(19) United States
(12) Patent Application Publication
(10) Pub. No.: US 2008/0265666 A1
(43) Pub. Date: Oct. 30, 2008

(54) Hydraulic recoil and adjustment mechanism

(75) Inventors: Richard Edward Livesay, Peoria, IL (US); Daniel Louis Mikrut, Chillicothe, IL (US); Albert Loyd Woody, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/790,585

(22) Filed: Apr. 26, 2007

(51) Int. Cl. B62D 55/30

(52) U.S. Cl. 305/149; 305/145

(57) ABSTRACT

A hydraulic recoil and adjustment mechanism is provided for a track assembly having an idler. The mechanism includes a recoil cylinder configured to contain a quantity of hydraulic fluid. A rod element is coupled to the idler and configured to reciprocate within the recoil cylinder. The idler is configured to exert a force on the rod element to drive hydraulic fluid from the recoil cylinder when the force exceeds a predetermined force. An accumulator includes a piston and is configured to contain a quantity of gas under pressure on one side of the piston, and to receive from the recoil cylinder a quantity of the hydraulic fluid on the other side of the piston when the force exceeds the predetermined force. An adjustment mechanism includes a reservoir for hydraulic fluid, and is configured to deliver hydraulic fluid from the adjustment mechanism to the recoil cylinder under sufficient pressure to move the rod element and the idler. A flow path is provided for hydraulic fluid between the recoil cylinder and the accumulator, and between the recoil cylinder and the adjustment mechanism.

### TECHNICAL FIELD

This disclosure relates generally to a hydraulic recoil and adjustment mechanism and, more particularly, to a hydraulic recoil and adjustment mechanism for the track assembly of a machine.

### BACKGROUND

A tracked machine, such as a track-type tractor or excavator, is typically supported and propelled by one or more track assemblies. Each track assembly may include an endless track having a plurality of interconnected articulating components or links. Each track assembly typically also includes a drive wheel or sprocket and one or more idler wheels. The track is advanced around the drive wheel and the one or more idler wheels, and this in turn may propel the machine along the ground.

During operation of the machine, it may be necessary to be able to accommodate various forces that may be exerted on the track. For example, stones and/or debris may intrude between an idler and the track, increasing tension on the track, potentially causing damage and resulting downtime for repair or track replacement. In addition, a mechanism may be provided to enable track removal and replacement or repair, and track adjustment for wear. Mechanisms designed to accommodate forces on tracks during machine operation and/or designed to enable track removal, replacement, and/or repair, may include coil springs or hydraulic cylinders and accumulators associated with the track assembly. Hydraulic recoil and adjustment mechanisms may include arrangements to both accommodate idler recoil movement, and move an idler to adjust track tension.

One system for accommodating hydraulic recoil and adjustment of an idler in a track assembly is disclosed in U.S. Pat. No. 6,682,155 issued to Hoffet al. (the '155 patent). The '155 patent discloses a mechanism which both accommodates idler recoil and provides for idler adjustment to alter track tension. In the mechanism of the '155 patent, recoil of an idler after a shock, such as a rock or debris being trapped within the track, is provided by a fluid filled recoil chamber in cooperation with an accumulator. Adjustment of the idler is accommodated by adding or removing grease from an adjustment chamber. The '155 patent also discloses a travel chamber and a travel piston in the hydraulic circuit with one or more drive motors for track drive wheels. The '155 patent optionally provides a valve to permit the hydraulic circuit for the drive motors to replenish the supply of fluid in the recoil chamber when needed.

While the mechanism of the '155 patent may have utility in accommodating idler recoil and adjustment, the system may be overly complicated. The combination recoil, adjustment, and travel cylinder may ultimately increase cost since, apparently, it may only be replaced as a unit inasmuch as it does not present a modular construction of individual components. In addition, the mechanism is connected to a hydraulic system including the drive motors for the track assemblies, and plumbing leading to the accumulator. This connection to a larger hydraulic system increases the chance of leaks through lines and fittings, as well as malfunction caused by failure of other system components.

The present disclosure is directed to solving one or more of the problems or disadvantages in current technology.

### SUMMARY OF THE INVENTION

According to one aspect of the present disclosure, a hydraulic recoil and adjustment mechanism is provided for a track assembly having an idler. The mechanism includes a recoil cylinder configured to contain a quantity of hydraulic fluid. A rod element is coupled to the idler and configured to reciprocate within the recoil cylinder. The idler is configured to exert a force on the rod element to drive hydraulic fluid from the recoil cylinder when the force exceeds a predetermined force. An accumulator includes a piston and is configured to contain a quantity of gas under pressure on one side of the piston, and to receive from the recoil cylinder a quantity of the hydraulic fluid on the other side of the piston when the force exceeds the predetermined force. An adjustment mechanism includes a reservoir for hydraulic fluid, and is configured to deliver hydraulic fluid from the adjustment mechanism to the recoil cylinder under sufficient pressure to move the rod element and the idler. A flow path is provided for hydraulic fluid between the recoil cylinder and the accumulator, and between the recoil cylinder and the adjustment mechanism.

According to another aspect of the disclosure, a method provides for recoil movement and adjustment of the idler of a track assembly. The method includes confining hydraulic fluid in a recoil cylinder associated with the idler. The method also includes confining gas under pressure within an accumulator on one side of a piston. The method further includes driving hydraulic fluid from the recoil cylinder through a flow path and into the accumulator against the opposite side of the piston responsive to a force of recoil movement of the idler toward the recoil cylinder that exceeds a predetermined force. The method also includes adjusting idler position by operating an adjustment mechanism to pump hydraulic fluid from a reservoir through the flow path into the recoil cylinder to increase the quantity of hydraulic fluid in the recoil cylinder and move the idler in a direction away from the recoil cylinder.

### BRIEF DESCRIPTION OF THE DRAWINGS

A more complete appreciation of this disclosure will be understood by reference to the following detailed description when considered in conjunction with the accompanying drawings in which like reference symbols indicate the same or similar components, wherein:

FIG. 1 is a side elevational view of an exemplary machine which incorporates an exemplary embodiment of the present disclosure therein;

FIG. 2 is an enlarged, partially cutaway side elevational view of an exemplary track assembly of the exemplary machine of FIG. 1, and incorporating an exemplary embodiment of the present disclosure therein; and

FIG. 3 is a schematic illustration of a hydraulic recoil and adjustment mechanism according to an exemplary embodiment of the present disclosure.

### DETAILED DESCRIPTION

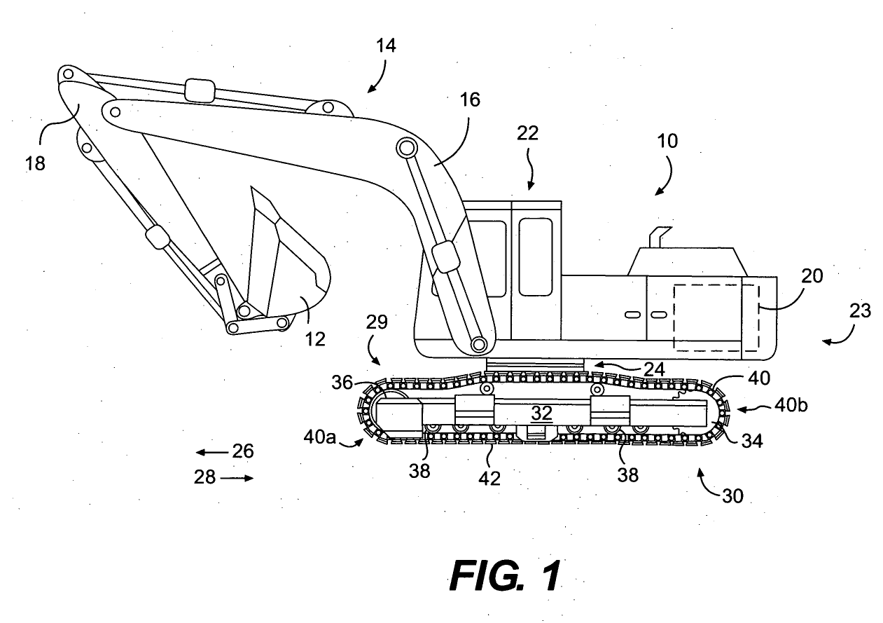

FIG. 1 illustrates one of a number of tracked machines which may incorporate a hydraulic recoil and adjustment mechanism according to this disclosure. For example, FIG. 1 illustrates a machine 10 in the form of a hydraulic excavator that may be employed to perform numerous operations, such as digging and material movement. It will be understood that, while machine 10 is illustrated as a hydraulic excavator, the hydraulic recoil and adjustment mechanism according to this disclosure may be incorporated in virtually any type of tracked machine. Machine 10 may include a number of work implements, such as, for example, a hydraulically-powered bucket assembly 12, which may be secured to an end of a boom assembly 14 having a boom arm 16 and a stick assembly 18. The machine 10 further may include a suitable engine 20 such as, for example, a diesel engine, for providing the motive power for both moving the machine 10 along the ground and operating the bucket assembly 12 and the boom assembly 14.

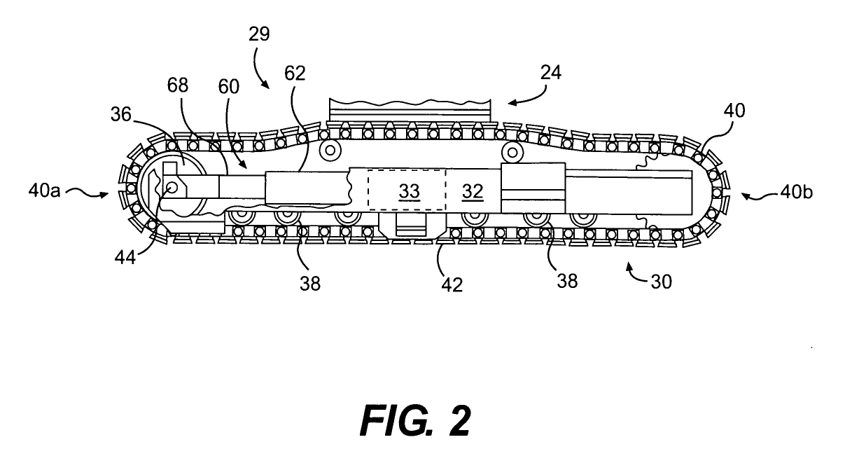

Machine 10 also may include a pair of track assemblies 30, although only one is shown in FIGS. 1 and 2. Each track assembly 30 generally may include a frame assembly 32, a drive wheel 34, an idler 36, such as an idler wheel, and one or more guides 38, such as guide rollers. For each track assembly 30, a drive track, such as, for example, an endless track 40, may be driven by the drive wheel 34 so as to be advanced around the idler 36 and the one or more guides 38, thereby providing the motive power for moving the machine 10. The drive wheel 34 may be driven by, for example a reversible hydraulic motor (not shown) to move the machine in either a forward direction 26 or a reverse direction 28. If desired, endless track 40 may be provided with low ground pressure (LGP) shoes 42. In addition, while in the exemplary embodiment illustrated in FIGS. 1 and 2 only a single idler 36 is shown, it will be understood that there may be plural idlers, depending on the shape of the track assembly.

It should be appreciated that drive wheel 34 may comprise a drive wheel which is frictionally engaged with the endless track 40 or a drive sprocket which is mechanically engaged with the endless track 40. In one embodiment, the idler 36 is positioned at a first end 40a of the track assembly 30, while the drive wheel 34 is positioned at a second and opposite end 40b of the track assembly 30. For simplicity of reference, the first end 40a at which the idler 36 is positioned is commonly described as the “front” of the machine 10 relative to a cab 22, while the second end 40b having the drive wheel 34 is described as the “rear.”

The cab 22 of the machine 10 may enclose or otherwise house devices associated with the machine 10 which may be employed by an operator during operation of the machine 10. Cab 22 may house an operator station (not shown) and a number of control devices, such as, for example, lever assemblies (not shown), and one or more foot pedal assemblies (not shown). The cab 22 may be part of a superstructure 23 which may be positioned via a swivel assembly 24 on an undercarriage 29 supported by the track assemblies 30 of the machine 10. The swivel assembly 24 may permit superstructure 23 to be turned in both the clockwise and counterclockwise directions relative to the undercarriage 29 and track assemblies 30.

As generally designated in FIG. 2, each track assembly 30 includes a hydraulic recoil and adjustment mechanism 60. The hydraulic recoil and adjustment mechanism 60, partially shown in FIG. 2, is configured to maintain the appropriate track tension, accommodate idler recoil due to external forces, and permit idler movement that may be necessary for track adjustment, removal, replacement, or repair, for example. Hydraulic recoil and adjustment mechanism 60 may be housed within frame assembly 32, and access to components of the hydraulic recoil and adjustment mechanism 60 may be provided via a suitable access door or doors (not shown). As can be seen generally in FIG. 2, hydraulic recoil and adjustment mechanism 60 may include a recoil cylinder 62 and an associated rod 68.

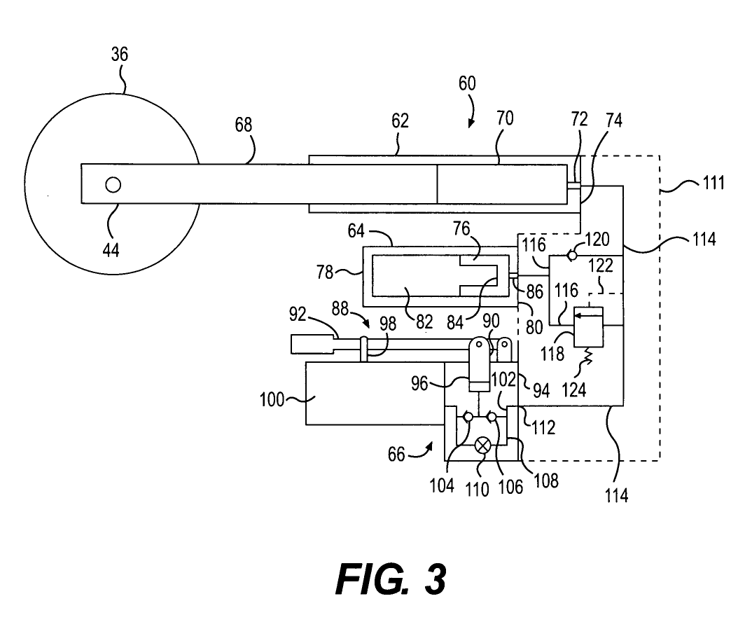

FIG. 3 is a schematic illustration of components of the hydraulic recoil and adjustment mechanism 60 shown, for ease of understanding, without the mechanical details of the track assembly 30. Hydraulic recoil and adjustment mechanism 60 includes, for example and among other components, hydraulic recoil cylinder 62, accumulator 64, and adjustment mechanism 66. It will be understood that the various components of the hydraulic recoil and adjustment mechanism, illustrated schematically in FIG. 3, in actual practice may be suitably and efficiently packaged within the confines of a track assembly 30.

Referring still to the exemplary embodiment illustrated in FIG. 3, hydraulic recoil cylinder 62 may include associated rod 68 which, in turn, may be suitably coupled, directly or through an intermediate coupling, to the supporting shaft 44 for idler 36. For example, rod 68 may be directly mounted to shaft 44 of idler 36 in such fashion that movement of idler 36, either to the right or left in FIG. 3, is transferred directly to rod 68, and vice versa. Hydraulic recoil cylinder 62 and its associated rod 68 may enclose a variable volume of hydraulic fluid within a chamber 70 formed by the hydraulic recoil cylinder 62 and its associated rod 68.

In the exemplary embodiment illustrated in FIG. 3, rod 68 is formed of a size to mate with the internal diameter of hydraulic recoil cylinder 62. In this example, hydraulic recoil cylinder 62 includes but the single chamber 70. Hydraulic recoil cylinder 62 may include a suitable port 72, for example at the cylinder end 74, through which hydraulic fluid may enter and exit the hydraulic recoil cylinder 62. It can be seen that movement of rod 68 to the right in FIG. 3, for example, due to an external force on idler 36, will tend to force hydraulic fluid within chamber 70 out of hydraulic recoil cylinder 62 through port 72.

An accumulator 64 may be associated with and included as a part of the hydraulic recoil and adjustment mechanism 60. Accumulator 64 may include a suitable piston, such as piston 76. Accumulator 64 may include a first end 78 and a second end 80. Variable space 82 may be formed in accumulator 64 between first end 78 and one side 84 of piston 76. Gas, such as air, nitrogen, or a suitable inert gas, for example, may be captured with the variable space 82 under pressure. Second end 80 of accumulator 64 may include a suitable port 86. Piston 76 is illustrated in a position against second end 80, maximizing variable space 82. This may be understood to be a normal mode for accumulator 64 and a normal position for piston 76 in which external forces on idler 36 are not sufficient to cause substantial movement of rod 68 within recoil cylinder 62. The manner of interaction between recoil cylinder 62 and accumulator 64, and the interchange of hydraulic fluid therebetween, will subsequently be explained in more detail.

Hydraulic recoil and adjustment mechanism 60 may include an adjustment mechanism 66. Adjustment mechanism 66 may include, for example, a suitable hand pump 88. Hand pump 88 may, for example, include a pumping element 90 which may be suitably manipulated manually by a handle 92. Handle 92, in the exemplary embodiment illustrated schematically in FIG. 3, may be suitably pivoted to a body 94, and handle 92 may be suitably coupled to pumping element 90, so that manipulation of handle 92 results in a pumping action of pumping element 90 within a pumping chamber 96. A suitable latch mechanism 98, schematically illustrated, may be provided to ensure that handle 92 remains securely in place during machine operation, and may be released to permit manipulation of handle 92 when desired.

Adjustment mechanism 66 may include a reservoir 100 associated with the body 94. Reservoir 100 may contain a supply of hydraulic fluid at least sufficient to fill chamber 70 of recoil cylinder 62 to its maximum contemplated capacity during machine operation. Reservoir 100 also may include sufficient hydraulic fluid to compensate for any wear or expansion of an endless track during machine operation. The manner of interaction between recoil cylinder 62 and adjustment mechanism 66, and the interchange of hydraulic fluid therebetween, will subsequently be explained in more detail.

Suitable valves and hydraulic flow paths may be associated with adjustment mechanism 66. For example, in the exemplary embodiment illustrated in FIG. 3, body 94 may include a flow path 102 permitting hand pump 88 to deliver hydraulic fluid from reservoir 100 to the recoil cylinder 62, and suitable valves to permit pumping action by pumping element 90 to effectuate fluid delivery. In the exemplary embodiment illustrated in FIG. 3, check valves 104 and 106 may be suitably located within the flow path 102 and configured to permit hand pump 88 to draw hydraulic fluid from reservoir 100 and delivery it toward recoil cylinder 62, while inhibiting the flow of hydraulic fluid in the reverse direction. For example, raising handle 92 may lift pumping element 90 and draw hydraulic fluid from reservoir 100 through check valve 104 and into pumping chamber 96. Then, lowering handle 92 may lower pumping element 90 into pumping chamber 96, forcing hydraulic fluid through check valve 106, through flow path 102, and through port 112.

According to the exemplary embodiment illustrated in FIG. 3, body 94 also may include a suitable flow path 108 and appropriate valve structure to permit, when desired, the flow of hydraulic fluid from the recoil cylinder 62 to the reservoir 100. For example, suitable valve structure associated with the flow path 108 may include a manual valve 110. When desired, for example, during track maintenance, repair, or adjustment, a mechanic may gain access to the adjustment mechanism 66 and manipulate manual valve 110 to an open position. When this is accomplished, hydraulic fluid contained with the chamber 70 of hydraulic recoil cylinder 62 may be forced, by machine manipulation of idler 36, into reservoir 100 for storage.

The foregoing discussion of the recoil cylinder 62, accumulator 64, and adjustment mechanism 66 presumes that one skilled in the art is well aware of the need for suitable flow paths for hydraulic fluid that may flow between such components. Still referring to the exemplary embodiment illustrated in FIG. 3, an exemplary valve block 110 is illustrated in dotted lines. Valve block 110, while not required, may be formed and situated to contain the necessary flow paths for hydraulic fluid that may flow between, for example, hydraulic recoil cylinder 62 and accumulator 64, and/or hydraulic recoil cylinder 62 and adjustment mechanism 66.

Describing the exemplary embodiment illustrated in FIG. 3 more specifically, hydraulic recoil cylinder 62, accumulator 64, and/or adjustment mechanism 66 may be mounted to valve block 110. Port 72 of hydraulic recoil cylinder 62, port 86 of accumulator 64, and port 112 of adjustment mechanism 66 may connect to a flow path within valve block 110. For example, the flow path may include a first flow path 114 provided to permit hydraulic fluid to flow between port 72 of hydraulic recoil cylinder 62 and port 112 of adjustment mechanism 66. In the exemplary embodiment illustrated in FIG. 3, a second flow path 116 may branch from first flow path 114 and provide for the flow of hydraulic fluid between port 72 of hydraulic recoil cylinder 62 and port 86 of accumulator 64. In this exemplary embodiment, flow of hydraulic fluid between recoil cylinder 62 and accumulator 64 includes second flow path 116 and a portion of first flow path 114, while flow of hydraulic fluid between recoil cylinder 62 and adjustment mechanism 66 includes only first flow path 114. Other flow path arrangements are contemplated to be within the scope of this disclosure.

Appropriate fluid communication between hydraulic recoil cylinder 62 and accumulator 64 may require relief valve 118 and check valve 120. Relief valve 118 and check valve 120 may preclude the flow of hydraulic fluid from hydraulic recoil cylinder 62 to accumulator 64 unless and until pressure within first flow path 114 rises to the level necessary to actuate and open the relief valve 118. If and when pressure in first flow path 114 achieves a pressure sufficient to actuate relief valve 118, then that pressure is transmitted through line 122 to move the valve element of relief valve 118 against spring 124 to open the relief valve 118, and permit the flow of hydraulic fluid from hydraulic recoil cylinder 62 into accumulator 64 through second flow path 116. Such flow of hydraulic fluid into accumulator 64 results in movement of piston 76 against the compressed gas within variable space 82. Such a situation occurs, for example, when an external force on idler 36 becomes sufficiently great to move the rod 68 further into chamber 70 of recoil cylinder 62, thus increasing the pressure of the hydraulic fluid in first flow path 114 above the predetermined pressure necessary to actuate and open relief valve 118.

At some point after relief valve 118 has been actuated and hydraulic fluid has flowed into accumulator 64, further compressing the gas within variable space 82, the event causing an external force on idler 36 sufficient to actuate the relief valve 118 may pass. At that time, pressure relief valve 118 may close as pressure within first flow path 114 reduces below the predetermined pressure necessary to actuate and open relief valve 118, and the pressure of the compressed gas within variable space 82 of accumulator 64 may force piston 76 against the hydraulic fluid which has flowed into accumulator 64, and cause the hydraulic fluid to flow through port 86, through second flow path 116, and through check valve 120, ultimately flowing back into chamber 70 of recoil cylinder 62 to return idler 36 to its normal operational position via rod 68.

As can be seen by reference to the exemplary embodiment illustrated in FIG. 3, valve block 110 may include accommodations for fluid communication between hydraulic recoil cylinder 62 and adjustment mechanism 66. For example, hydraulic fluid from reservoir 100 of adjustment mechanism 66 may be pumped, via hand pump 88, through port 112 and through first flow path 114 in valve block 110 to chamber 70 of hydraulic recoil cylinder 62. In addition, it may become necessary or desirable to empty chamber 70 of hydraulic recoil mechanism 62 of hydraulic fluid, such as during repair or replacement of the endless track 40. In such a situation, opening manual valve 110 may permit flow of hydraulic fluid from chamber 70 of hydraulic recoil cylinder 62 through port 72, through first flow path 114 in valve block 110, through port 112, and into reservoir 100 of adjustment mechanism 66.

### INDUSTRIAL APPLICABILITY

The disclosed embodiments describe a relatively simple, compact, and robust mechanism for accommodating idler recoil and adjustment in tracked machines. The recoil cylinder 62, accumulator 64, adjustment mechanism 66, and all associated hydraulic fluid, hydraulic flow paths, and valves may be packaged to be housed entirely within the confines of a frame assembly 32 of a track assembly 30 without any external lines or fittings that may tend to leak.

It should be apparent to one skilled in the art that the various components of the disclosed hydraulic recoil and adjustment mechanism may be sized commensurate with the type and size of machine on which the mechanism may be employed. For example, in a typical embodiment, the mechanism may be sized for 4,000 lbs. track slack, 60,000 lbs. recoil preload, 4.4 inches of recoil movement, and 1.6 inches of adjustment. Hydraulic recoil cylinder 62 may be, for example, approximately 6 inches in outside diameter, and rod 68 may be approximately 4.5 inches in diameter with an area of approximately 16 square inches contacting the hydraulic fluid in chamber 70.

The 4,000 lbs. slack force on idler 36 may generate a pressure of 250 psi in the recoil cylinder 62. Relief valve 118 may be set at 3,750 psi, which is equivalent to a 60,000 lbs. force from idler 36 against recoil cylinder 62. Accumulator 64 may be sized to accept the volume of hydraulic fluid which allows for full recoil of, for example, 4.4 inches of movement of idler 36. Because recoil cylinder 62 is a separate component from accumulator 64 and adjustment mechanism 66, all horizontal loads may pass through the hydraulic recoil cylinder 62 into the frame assembly 32 to which the hydraulic recoil cylinder 62 is mounted, bypassing the accumulator and adjustment mechanism.

The gas (e.g., air, nitrogen, inert gas, etc.) under pressure in accumulator 64 may be precharged to a pressure of, for example, four times slack force, which is the idler force with new, clean, standard track. Accumulator may be, for example, a 4 inch, 3000 psi, piston accumulator, with gas on one side of the piston and hydraulic fluid on the other side of the piston. Four times the idler force, or load, is 16,000 lbs. and is equivalent to a pressure of 1254 psi. Such a precharge for the gas in accumulator 64 may position the piston 76 against the end 80 of the accumulator 64, and is more than adequate to return idler 36 to its original position properly tensioning clean, new track. On the other hand, track weights could be 25% heavier with a full load of clay, and 50% heavier when outfitted with LGP shoes, for example. Because the precharge is set as much as four time slack force (16,000 lbs. versus 4,000 lbs.), generating an idler return force four times that necessary to accommodate new track, there is a high degree of certainty that the track will be reliably returned to proper tensioning position regardless of any additional clay weight and/or LGP shoes, for example.

Temperature may affect the pressure within accumulator 64. Even during cold temperature operation, which may reduce the available idler return force of accumulator 64, the return force may still be, for example 3.4 times new track weight, and more than adequate to assure return of idler 36 to its original position. At high temperatures and when an event results in full recoil of idler 36, gas pressure in accumulator 64 may increase to 3000 psi, which may be a safe peak operating pressure for the accumulator 64 by design. Accordingly, accumulator 64 is designed to reliably return the idler 36 to its original operating position regardless of temperature variations or track weights. An example of a piston-type accumulator that may be suitable for accumulator 64 is one sold under the designation Parker A4N00581K.

The adjustment mechanism 66 may be designed to contain sufficient hydraulic fluid within reservoir 100 to accommodate any needed adjustment of idler 36 due, for example, to track wear or expansion. For example, in a typical arrangement, necessary idler movement for adjustment may be approximately 1.6 inches. In order to adjust idler 32, a mechanic, for example, may open one or more access doors (not shown) on the frame assembly 32 to access the adjustment mechanism 66. Once accessed, latch mechanism 98 may be manipulated to permit movement of handle 92 and operation of hand pump 88 to pump hydraulic fluid from reservoir 100 into recoil cylinder 62, to thereby adjust idler 36.

Adjustment mechanism 66 may permit necessary movement of idler 36 to relieve tension on an endless track 40 in circumstances where it is necessary or desirable to repair or replace the track. In such an event, after gaining access to the adjustment mechanism 66, manual valve 110 may be opened, permitting hydraulic fluid to flow from the recoil cylinder 62 to the reservoir 100. The machine operator may manipulate the machine, such as machine 10, to exert sufficient force on the idler 36 while manual valve 110 is open to force the hydraulic fluid from chamber 70 of hydraulic recoil cylinder 62 to reservoir 100. In this way, the idler 36 may be fully retracted, permitting service operations on the track.

In order to move the idler 36 forward to a track tensioning position, the manual valve 110 may be moved to a closed position. Then, hand pump 88 may be operated via handle 92 to pump hydraulic fluid from reservoir 100 back into chamber 70 of hydraulic recoil cylinder 62. This moves idler 36 to a position reestablishing correct track slack tension. During use of the adjustment mechanism 66, the check valve 120 and relief valve 118 located in second flow path 116 preclude hydraulic fluid from reaching accumulator 64. Adjustment mechanism 66 may be sized with reservoir 100 sufficient to accommodate enough hydraulic fluid to initially fill the hydraulic recoil and adjustment mechanism, plus enough to permit the maximum amount of adjustment for track wear that may be permitted. No hydraulic fluid is exhausted from the hydraulic recoil and adjustment mechanism 60. An example of a hydraulic hand pump that may be suitable as hand pump 88 is one sold under the designation Enerpac Model P80 which may deliver fluid at a pressure of approximately 10,000 psi.

It will be understood that the foregoing specific parameters are given as examples that may be employed in an exemplary embodiment, and are not in any way limiting. The dimensions of the recoil cylinder 62, rod 68, accumulator 64, and reservoir 100, for example, and the various pressures, including the predetermined pressure at which relief valve 118 may be actuated, may vary in accordance with the particular application in which the hydraulic recoil and adjustment mechanism 60 is employed.

The disclosed hydraulic recoil and adjustment mechanism balances system simplicity with robustness and reliability of operation. The separate and individually simple recoil cylinder 62, accumulator 64, and adjustment mechanism 66 components offer a modular construction that may be packaged compactly within the confines of a track assembly 30, and with no connection to other machine hydraulics. Mounting each of the recoil cylinder 62, accumulator 64, and adjustment mechanism 66 on a valve block which includes necessary flow paths between the components and valves associated with accumulator 64 attributes further to compact packaging and minimizes leakage by eliminating external lines and fittings. Use of a simple and robust manually operated pump offers a reliable way to effect track adjustment, repair, and/or replacement in rough conditions in the field without loss of hydraulic fluid from the system.

While exemplary embodiments have been disclosed, other embodiments will be apparent to those having ordinary skill in the art from consideration of the specification and practice of the disclosed embodiments. It is intended that the specification and examples be considered as exemplary only with the true scope of protection being indicated by the following claims.

1. A hydraulic recoil and adjustment mechanism for a track assembly having an idler, the mechanism comprising:
a recoil cylinder configured to contain a quantity of hydraulic fluid;
a rod element coupled to the idler and configured to reciprocate within the recoil cylinder, the idler configured to exert a force on the rod element to drive hydraulic fluid from the recoil cylinder when the force exceeds a predetermined force;
an accumulator including a piston and configured to contain a quantity of gas under pressure on one side of the piston, and to receive from the recoil cylinder a quantity of the hydraulic fluid on the other side of the piston when the force exceeds the predetermined force;
an adjustment mechanism, the adjustment mechanism including a reservoir for hydraulic fluid and a hydraulic hand pump for manually pumping hydraulic fluid from the reservoir to the recoil cylinder under sufficient pressure to move the rod element and the idler; and
a flow path for hydraulic fluid between the recoil cylinder and the accumulator, and between the recoil cylinder and the adjustment mechanism,
wherein the recoil cylinder, the rod element, the accumulator, and the adjustment mechanism are housed within the track assembly.

2. (canceled)

3. The hydraulic recoil and adjustment mechanism of claim 1, wherein the adjustment mechanism includes a manual valve configured to permit hydraulic fluid in the recoil cylinder to flow, via the flow path, to the reservoir.

4. The hydraulic recoil and adjustment mechanism of claim 1, further including a relief valve in the flow path for hydraulic fluid between the recoil cylinder and the accumulator, the relief valve configured to open at the predetermined force to permit hydraulic fluid in the recoil cylinder to flow into the accumulator against the other side of the piston.

5. The hydraulic recoil and adjustment mechanism of claim 4, further including a valve configured to permit fluid that has flowed through the relief valve into the accumulator to flow back from the accumulator to the recoil cylinder when the force falls below the predetermined force and the relief valve closes.

6. The hydraulic recoil and adjustment mechanism of claim 1, further including a valve block, the valve block including the flow path for hydraulic fluid, and wherein the recoil cylinder, the accumulator, and the adjustment mechanism are each mounted directly to the valve block.

7. A method providing for recoil movement and adjustment of the idler of a track assembly, the method comprising:
confining hydraulic fluid in a recoil cylinder associated with the idler;
confining gas under pressure within an accumulator on one side of a piston;
driving hydraulic fluid from the recoil cylinder through a flow path and into the accumulator against the opposite side of the piston responsive to a force of recoil movement of the idler toward the recoil cylinder that exceeds a predetermined force; and
operating a hand pump of an adjustment mechanism housed within the track assembly to adjust idler position by pumping hydraulic fluid from a reservoir of the adjustment mechanism through the flow path into the recoil cylinder to increase the quantity of hydraulic fluid in the recoil cylinder and move the idler in a direction away from the recoil cylinder.

8. The method of claim 7, further including driving hydraulic fluid from the recoil cylinder into the accumulator via a relief valve set to open at the predetermined force.

9. The method of claim 8, further including returning the hydraulic fluid from the accumulator back to the recoil cylinder by the pressure exerted by the confined gas when the force falls below the predetermined force.

10. The method of claim 7, further including opening a manual valve associated with the adjustment mechanism to permit hydraulic fluid to be forced from the recoil cylinder into the reservoir by movement of the idler in a direction toward the recoil cylinder.

11. The method of claim 7, including accessing the adjustment mechanism by opening a frame included in the track assembly, operating the hand pump to pump hydraulic fluid from the reservoir into the recoil cylinder to adjust the position of the idler in a direction to tighten an endless track of the track assembly, and opening a manual valve associated with the hand pump to permit movement of the idler in a direction to loosen the endless track and to permit the flow of hydraulic fluid from the recoil cylinder to the reservoir.

12. The method of claim 7, further including operating a machine associated with the track assembly to exert forces on the idler to move a rod in a first direction within the recoil cylinder;
forcing the hydraulic fluid, via movement of the rod, from the recoil cylinder through the flow path into the accumulator against the opposite side of the piston to compress the gas on the one side of the piston, and
subsequently forcing the hydraulic fluid, via the pressure of the gas on the one side of the piston, from the accumulator through a check valve and into the recoil cylinder to move the rod in a second direction opposite the first direction.

13. A machine, comprising:
a track assembly supporting the machine for ground contact, the track assembly including an endless track, a drive assembly for driving the endless track, and an idler;
a recoil cylinder configured to contain a quantity of hydraulic fluid;
a rod element coupled to the idler and configured to reciprocate within the recoil cylinder in response to movement of the idler in recoil, the idler configured to exert a force on the rod element to drive hydraulic fluid from the recoil cylinder when the force exceeds a predetermined force;
an accumulator including a piston and configured to contain a quantity of gas under pressure on one side of the piston, and to receive a quantity of the hydraulic fluid on the other side of the piston when the force exceeds the predetermined force and hydraulic fluid is driven from the recoil cylinder by the rod element; an adjustment mechanism, the adjustment mechanism including a reservoir for hydraulic fluid and a hydraulic hand pump for manually pumping hydraulic fluid from the reservoir to the recoil cylinder under sufficient pressure to move the rod element and the idler; and
a flow path for hydraulic fluid between the recoil cylinder and the accumulator, and between the recoil cylinder and the adjustment mechanism,
wherein the recoil cylinder, the rod element, the accumulator, and the adjustment mechanism are housed within the track assembly.

14. (canceled)

15. The machine of claim 13, wherein the hand pump includes a handle configured for manual actuation, and a latch mechanism for retaining the handle secure during machine operation.

16. The machine of claim 13, wherein the adjustment mechanism includes a manual valve configured to permit hydraulic fluid in the recoil cylinder to flow, via the flow path, to the reservoir.

17. The machine of claim 13, further including a valve block, the valve block including the flow path for hydraulic fluid, and wherein the recoil cylinder, the accumulator, and the adjustment mechanism are each mounted directly to the valve block.

18. The machine of claim 13, further including a relief valve in the flow path for hydraulic fluid between the recoil cylinder and the accumulator, the relief valve configured to open at the predetermined force to permit hydraulic fluid in the recoil cylinder to flow into the accumulator against the other side of the piston.

19. The machine of claim 18, further including a valve configured to permit fluid that has flowed through the relief valve into the accumulator to flow back from the accumulator to the recoil cylinder when the force falls below the predetermined force and the relief valve closes.

20. The machine of claim 13, wherein each of the recoil cylinder, the accumulator, and the adjustment mechanism includes a port for permitting the flow of hydraulic fluid, and further including:
a valve block, with each of the recoil cylinder, the accumulator, and the adjustment mechanism mounted to the valve block with its respective port abutting the valve block;
wherein the flow path includes a first flow path within the valve block extending from the port of the recoil cylinder to the port of the adjustment mechanism, and a second flow path within the valve block and connected between the port of the accumulator and the first flow path;
a relief valve in the second flow path configured to permit the flow of hydraulic fluid from the recoil cylinder to the accumulator; and
a check valve in the second flow path configure to permit the flow of hydraulic fluid from the accumulator to the recoil cylinder.
